(19) United States
(12) Patent Application Publication
(10) Pub. No.: US 2024/0397907 A1
(43) Pub. Date: Dec. 5, 2024

(54) ROTARY MILKING PARLOR ARRANGEMENT, COMPUTER-IMPLEMENTED METHOD, COMPUTER PROGRAM AND NON-VOLATILE DATA CARRIER

(71) Applicant: DELAVAL HOLDING AB, Tumba (SE)

(72) Inventor: Tomasz LESNIAK, Tumba (SE)

(21) Appl. No.: 18/700,644

(22) PCT Filed: Oct. 12, 2022
(86) PCT No.: PCT/SE2022/050923

§ 371 Date: Apr. 11, 2024

(30) Foreign Application Priority Data
Oct. 12, 2021 (SE) 2130274-0

(51) Int. Cl. A01K 1/12; A01J 5/007

(52) U.S. Cl. CPC A01K 1/126; A01J 5/007

(57) ABSTRACT

A rotary milking parlor arrangement contains a rotating platform with stalls configured to house a respective animal during milking, a set of at least three drive units causing the rotating platform to move in a first rotational direction, and a primary control unit controlling operation of each drive unit in the set of drive units. A set of links connect the drive in a ring network in including the primary control unit. Each link is bi-directional. The primary control unit identifies any single faulty link in the set of links by: transmitting a first signal in a clockwise direction through the ring network, transmitting a second signal in a counter clockwise direction through the ring network, and checking how far the first and second signals can be transmitted through the ring network in the clockwise and counter clockwise direction respectively without being interrupted by the single faulty link.

### TECHNICAL FIELD

The present invention relates generally to control of rotary milking parlors. Especially, the invention relates to a rotary milking parlor arrangement according to the preamble of claim 1 and a corresponding computer-implemented method. The invention also relates to a computer program and a non-volatile data carrier storing such a computer program.

### BACKGROUND

A rotary milking parlor enables highly efficient extraction of milk from large number of dairy animals. However, due to the size and weight of the rotating platform, a rotary milking parlor is potentially also a very dangerous piece of equipment both for the animals and the humans who may be jammed or hit by items on the platform. For safety reasons it is therefore important that the rotating platform can be brought to a halt within a prescribed braking distance or interval. This, in turn, requires reliable operation of the drive units, which are responsible for driving as well as braking the platform.

WO 2018/226144 describes a rotary milking parlor that is controlled using a set of sensors generating sensor signals reflecting whether or not an entity is deemed to be located at a hazardous position relative to the rotary milking parlor. Each sensor generates first and second independent signals for detecting one particular condition. The first and second signals are conveyed via first and second signal lines respectively to a central control unit. The rotary milking parlor is only allowed to be operated if both the first and second signals of all sensors in the set of sensors indicate that no entity is deemed to be located at a hazardous position.

Thus there is a technical solution for safeguarding that the rotary milking parlor is operable exclusively when no human or animal is in a dangerous position in relation to the rotating platform. However, the above mentioned safety issue of ensuring robust and reliable operation of the drive units and in particular that of ensuring safe braking distance of the rotating platform remains to be further improved.

### SUMMARY

The object of the present invention is therefore to offer a solution that provides an enhanced reliability in the operation of the drive units and ensures that the rotating platform can be brought to a halt within a prescribed braking distance or interval even if a communication link to one of the drive units is broken, or damaged. A further object is that of facilitating and enhancing the flexibility in the installation of any desired number of drive units depending on the size of the rotary milking parlor.

According to one aspect of the invention, the object is achieved by a rotary milking parlor arrangement containing a rotating platform, a set of drive units and a primary control unit. The rotating platform has a plurality of stalls each of which is configured to house a respective animal during milking. The set of drive units is configured to cause the rotating platform to move in at least a first direction of rotation around a rotation axis. The primary control unit is configured to control operation of each drive unit in the set of drive units, which contains at least three drive units. A set of links is connecting the drive units in the set of drive units in a ring network in which the primary control unit is also included. Each link in the set of links is bi-directional enabling signals to pass in both directions. Specifically, this means that signals, for example control signals may pass bidirectionally between the primary control unit and a first drive unit in the set of drive units, between a last drive unit in the set of drive units and the primary control unit, as well as between each consecutive pair of drive units between the first drive unit and the last drive unit. The primary control unit is further configured to identify any single faulty link in the set of links by: transmitting a first signal in a clockwise direction through the ring network, transmitting a second signal in a counter clockwise direction through the ring network, and checking how far each of the first and second signals can be transmitted through the ring network in the clockwise and counter clockwise direction respectively without being interrupted by the single faulty link. In this way, the primary control unit is sending a message in the form of said first/second signals and waiting for a response by checking if said first/second signals are received at the other end of the ring network. An error on the line may be indicated if the response (a received first/second signal at other end) cannot be confirmed. It is further possible to detect the faulty link based on how far “good” first/seconds signal goes uninterrupted through the ring network.

This rotary milking parlor is advantageous because it renders it possible to pinpoint a single faulty link, e.g. an Ethernet cable or optic cable, so that adequate repair actions can be planned. Moreover, by sending control signals to the drive unit in question via the ring network from a direction opposite to the direction of the faulty link, the rotating platform may be continued to be operated with maintained reliability while waiting for the repair actions to be performed. This redundancy in functionality makes the ring network according to the invention generally preferable to a star network. Additionally, the ring network facilitate the installation of drive units and provides enhanced flexibility in its basic architecture, because the ring architecture enables the connection of any desired number of drive units in series into a single (one-sized) control box. Hence, this architecture is easily adaptable to any desired number of drive units, which generally increases in number with the size of the rotating platform. The bi-directional ring network of the present invention is hereby particularly beneficial in ensuring a reliable operation and simplifying the installation of larger sized rotary milking parlors that may include up to sixteen drive units.

According to one embodiment of this aspect of the invention, the links in the set of links are further configured to feed electric power from the primary control unit to each drive unit in the set of drive units. This means that the links may be implemented by power cables, and the first and second signals as well as any control signals may be sent on a power-line carrier (PLC) signal format. This is advantageous because thereby no dedicated signalling cabling to the drive units is required.

According to another embodiment of this aspect of the invention, the arrangement further contains a secondary control unit and a set of galvanic connections connecting the drive units in the set of drive units in a loop configuration in which the secondary control unit is included. Analogous to the primary control unit, the secondary control unit is configured to control the operation of each drive unit in the set of drive units. Each galvanic connection in the set of galvanic connections is bi-directional, so that signals are enabled to pass in both directions: between the secondary control unit and the first drive unit in the set of drive units, between the last drive unit in the set of drive units and the secondary control unit, as well as between each consecutive pair of the drive units between the first drive unit and the last drive unit. In further analogy to the primary control unit, the secondary control unit configured to identify any single faulty galvanic connection of the set of galvanic connections by: transmitting a third signal in a clockwise direction through the loop configuration, transmitting a fourth signal in a counter clockwise direction through the loop configuration, and checking how far each of the third and fourth signals can be transmitted through the loop configuration in the clockwise and counter clockwise direction respectively without being interrupted by the single faulty galvanic connection. This is advantageous because thereby it is possible to pinpoint a single faulty galvanic connection, e.g. a power cable, to a drive unit, so that adequate repair actions can be planned. Moreover, by feeding electric power to the drive unit in question via the loop configuration from a direction opposite to the direction of the faulty galvanic connection, the rotating platform may be continued to be operated based on this drive unit. Consequently, the reliability can be maintained while waiting for the repair actions to be performed.

According to yet another one embodiment of this aspect of the invention, the third and fourth signals are control signals. Thereby, the galvanic connections may also be used for control purposes.

According to still another embodiment of this aspect of the invention, the primary control unit is configured to obtain status information via the ring network, which status information reflects at least one operation condition of the drive units in the set of drive units. The arrangement also contains a central communication link interconnecting the primary and secondary control units, and the primary control unit is further configured to repeatedly transmit the status information to the secondary control unit via the central communication link. As a result, the secondary control unit will retain updated status information about the least one operation condition of the drive units. Thus, the secondary control unit may take over the responsibilities of the primary control unit if needed, for example if the primary control unit malfunctions, while the secondary control unit may run the rotating platform on basis of the latest updated status information about the operation condition of the drive units.

According to another embodiment of this aspect of the invention, the at least one operation condition reflected by the status information contains a respective indicator for each drive unit in the set of drive units, which respective indicator specifies whether the drive unit operates with an acceptable level of performance. Consequently, the secondary control unit is kept updated about whether each drive unit performs acceptably. Of course, this is key information should the secondary control unit need to take over the responsibility for operating the drive units.

According to yet another embodiment of this aspect of the invention, each of the primary and secondary control units is configured to cause the rotating platform to move at a rotation speed up to a threshold speed. The threshold speed, in turn, is assigned based on a functioning number designating how many drive units in the set of drive units that operate with the acceptable level of performance. The threshold speed is assigned a maximum value only if the functioning number designates that all drive units in the set of drive units operate with the acceptable level of performance. Namely, in such a case, the drive units have the best chances of decelerating the rotating platform, and thus stopping it quickly. Preferably, if one or more drive units operate at a reduced level of performance, the threshold speed is lowered from the maximum value in proportion to the number of drive units operating at the reduced level of performance. Hence, the safety can be held at a reasonable level even if the rotary milking parlor arrangement must be temporarily operated with one or more faulty drive units.

According to still another embodiment of this aspect of the invention, the arrangement contains a first user interface, e.g. a touchscreen, configured to convey a first set of operating commands to the primary control unit. The first set of operating commands may involve operating commands to run the rotating platform in a fully automatic manner, yet it may also include a portion of the first user interface that enables manual operating commands (forward/reverse, speed adjustments and stopping commands) of the rotating platform. The first set of operating commands are configured to control a movement of the rotating platform via signalling over the ring network to the set of drive units, for example so that the rotating platform moves at a certain speed in a first (forward) direction. The arrangement further contains a second user interface, e.g. an array of buttons, configured to convey a second set of operating commands to both the primary control unit and the secondary control unit. The second set of operating commands are likewise configured to control the movement of the rotating platform, and may thus mirror the first set of operating commands. The second set of operating commands control the movement of the rotating platform via signalling through the primary control unit over the ring network to the set of drive units. Additionally, the second set of operating commands control the movement of the rotating platform via signalling through the secondary control unit over the loop configuration to the set of drive units. As a result, the second user interface provides a backup to the primary user interface, so that regardless of whether the primary control unit works as intended, a user may control the rotating platform via the second user interface.

According to an additional embodiment of this aspect of the invention, the secondary control unit is configured to be activated exclusively if the primary control unit suffers from a malfunction affecting the primary control unit's capability to control the movement of the rotating platform. Consequently, the secondary control unit only constitutes a backup control means for the rotating platform; and during normal operation, the user need only pay attention to the first user interface.

According to another aspect of the invention, the object is achieved by a computer-implemented method, which is performed in at least one processor in a control unit of a rotary milking parlor arrangement containing a rotating platform with a plurality of stalls each of which is configured to house a respective animal during milking, and a set of at least three drive units connected by bi-directional links in a ring network in which the primary control unit is included, which bi-directional links enable signals to pass in both directions. Specifically, according to the invention, the bi-directional links enable signals to pass in both directions: between the primary control unit and a first drive unit in the set of drive units, between a last drive unit in the set of drive units and the primary control unit, as well as between each consecutive pair of drive units between the first drive unit and the last drive unit. The method involves controlling the set of drive units to cause the rotating platform to move in at least a first direction of rotation around a rotation axis. The method further involves identifying any single faulty link in the set of links by: transmitting a first signal in a clockwise direction through the ring network, transmitting a second signal in a counter clockwise direction through the ring network, and checking how far each of the first and second signals can be transmitted through the ring network in the clockwise and counter clockwise direction respectively without being interrupted by the single faulty link. The advantages of this method, as well as the preferred embodiments thereof, are apparent from the discussion above with reference to the proposed system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows an example of a rotating platform that may be included in a rotary milking parlor arrangement according to the invention;

FIG. 2 illustrates, schematically, how a set of drive units act on a drive rail to cause the rotating platform move in according to one embodiment of the invention;

FIGS. 3a-d exemplifies a ring network for controlling the drive units according to one embodiment of the invention;

FIG. 4 exemplifies how a loop configuration of galvanic connections may interconnect the drive units according to one embodiment of the invention;

FIG. 5 shows a block diagram of rotary milking parlor arrangement according to one embodiment of the invention;

FIG. 6 illustrates details of a drive unit according to one embodiment of the invention;

FIG. 7 shows a primary control unit according to one embodiment the invention; and

FIG. 8 illustrates, by means of a flow diagram, the general method according to the invention.

### DETAILED DESCRIPTION

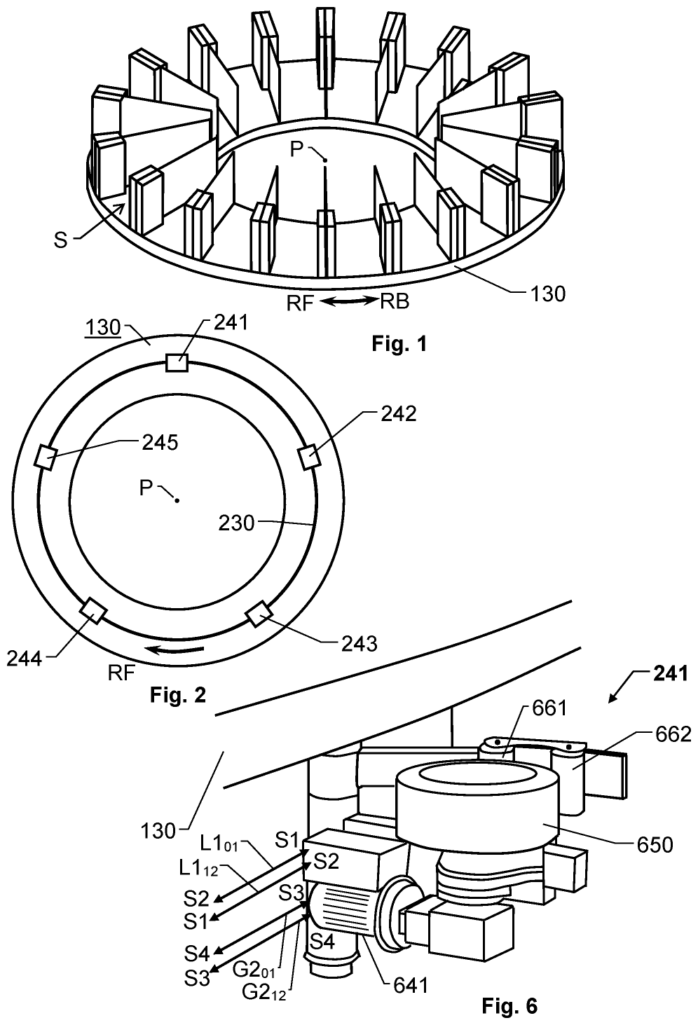

FIG. 1 exemplifies a rotating platform 130 included in a rotary milking parlor arrangement according to the invention. FIG. 2 shows a schematic view of the rotating platform 130 from below. The rotating platform 130 has a plurality of stalls S each of which is configured to house a respective animal during milking.

A set of drive units, shown as 241, 242, 243, 244 and 245 respectively in FIG. 2, is configured to cause the rotating platform 130 to move around a rotation axis P in a forward direction of rotation RF and/or a backward direction of rotation RB. Each of the drive units 241, 242, 243, 244 and 245 contains at least one motor arranged to engage a drive surface of the rotating platform 130, for instance in the form of a drive rail 230, and thus exert a respective drive force on the rotating platform 130. FIG. 2 shows five drive units. However, according to the invention, the set of drive units may include any number of drive units from three and up. In particular the invention is beneficially implemented on a larger sized rotating platform that may include as many as sixteen drive units. The number of stalls S provided on such rotating platforms may exceed one hundred.

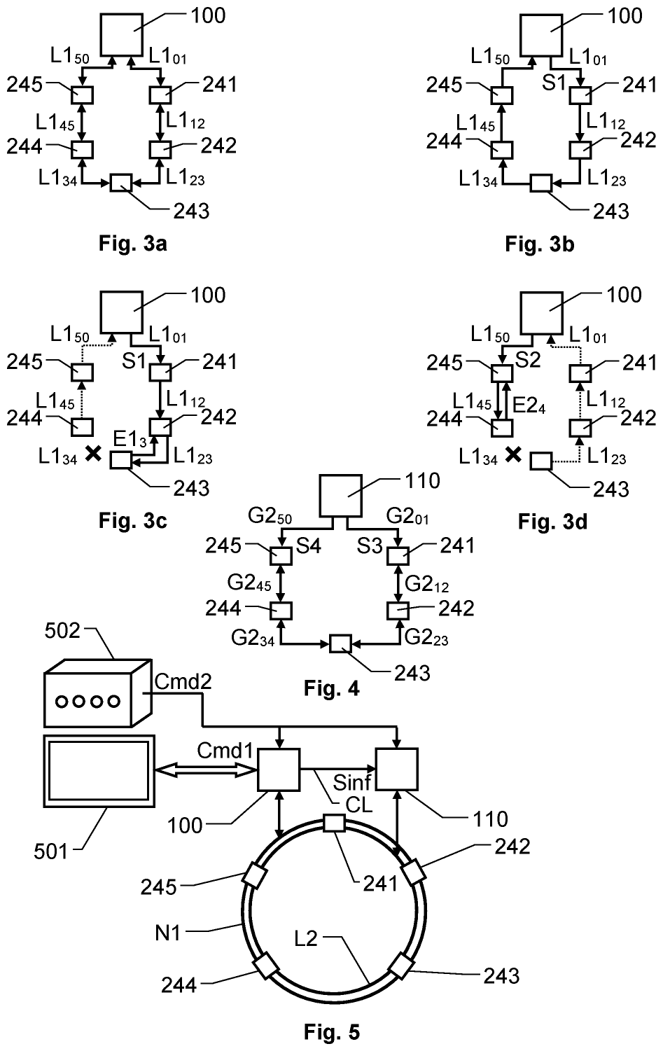

Referring now to FIGS. 3a to 3d and 5, we see a primary control unit 100, which is configured to control the operation of each drive unit in the set of drive units 241, 242, 243, 244 and 245.

The arrangement according to the invention also contains a set of links L1₀₁, L1₁₂, L1₂₃, L1₃₄, L1₄₅ and L1₅₀ connecting the drive units 241, 242, 243, 244 and 245 in a ring network N1 in which the primary control unit 100 is included.

Each of the links L1₀₁, L1₁₂, L1₂₃, L1₃₄, L1₄₅ and L1₅₀ is bi-directional enabling signals to be passed in both directions between two neighboring drive units in the set of drive units 241, 242, 243, 244 and 245, as well as between the primary control unit 100 and the drive units connected thereto.

Specifically, the bidirectional links L1₀₁, L1₁₂, L1₂₃, L1₃₄, L1₄₅ and L1₅₀ render it possible for first and second signals S1 and S2 respectively to pass in both directions: between the primary control unit 100 and the first drive unit 241; between the last drive unit 245 and the primary control unit 100; as well as between each consecutive pair of drive units between the first drive unit 241 and the last drive unit 245, i.e. between 241 and 242, 242 and 243, 243 and 244, and 244 and 245 respectively.

The primary control unit 100 is configured to identify any single faulty link in the set of links L1₀₁, L1₁₂, L1₂₃, L1₃₄, L1₄₅ and L1₅₀ by transmitting signals through the ring network N1. More precisely, the primary control unit 100 is configured to effect the following procedure to identify a single faulty link:
transmitting the first signal S1 in a clockwise direction through the ring network N1;
transmitting a second signal S2 in a counter clockwise direction through the ring network N1, and
checking how far each of the first and second signals S1 and S2 can be transmitted through the ring network N1 in the clockwise and counter clockwise direction respectively.

If all the links L1₀₁, L1₁₂, L1₂₃, L1₃₄, L1₄₅ and L1₅₀ in the ring network N1 function flawlessly, both the first and second signals S1 and S2 will arrive at the primary control unit 100 shortly after being transmitted therefrom. Namely, the first signal S1 will be received from the last drive unit 245 via the link L1₅₀ and the second signal S2 will be received from the first drive unit 241 via the link L1₁₀.

If, however, one of the links L1₁₀, L1₁₂, L1₂₃, L1₃₄, L1₄₅ and L1₅₀ in the ring network N1, say L1₃₄, is broken/incapable of forwarding signals, none of the first or second signals S1 and S2 will return to the primary control unit 100 as described above.

In such a case, i.e. if the primary control unit 100 does not receive the first and second signal S1 and S2 within a threshold period, the primary control unit 100 is configured to:
check how far the first signal S1 can be transmitted through the ring network N1;
check how far the second signal S2 can be transmitted through the ring network N1, and based thereon
determine which link that is faulty.

Referring now to FIG. 3c, and assuming that the link L1₃₄ is broken/incapable of forwarding signals, the first signal S1 will be passed on through the ring network N1 until it reaches the third drive unit 243. Due to the faulty link L1₃₄, the first signal S1 cannot reach the fourth drive unit 244. Therefore, in response to not being able to transmit the first signal S1 to the fourth drive unit 244, the third drive unit 243 may for instance transmit a first error message E1₃ back through the chain of drive units before the third drive unit 243 in the ring network N1 to the primary control unit 100, i.e. via 242 and 241, which first error message E1₃ indicates that the first signal S1 reached the third drive unit 243.

Referring to FIG. 3d, and assuming that the link L1₃₄ is broken/incapable of forwarding signals, the second signal S2 will be passed on through the ring network N1 until it reaches the fourth drive unit 244. Due to the faulty link L1₃₄, the second signal S2 cannot reach the third drive unit 243. Therefore, in response to not being able to transmit the second signal S2 to the third drive unit 243, the fourth drive unit 244 may for instance transmit a second error message E2₄ back to the primary control unit 100 through the ring network N1 via the fifth drive unit 245, which second error message E2₄ indicates that the second signal S2 reached the fourth drive unit 244.

After having received the first and second error messages E1₃ and E2₄ respectively, the primary control unit 100 may conclude that the first signal S1 could be transmitted through the ring network N1 to the third drive unit 243, whereas the second signal S2 could be transmitted through the ring network N1 to the fourth drive unit 244. In the light of this, the primary control unit 100 can determine that link L1₃₄ is faulty.

The links L1₀₁, L1₁₂, L1₂₃, L1₃₄, L1₄₅ and L1₅₀ may be represented by electric and/or optic signal cables, for example Ethernet cables and/or fiber optic lines. Thus, the first and second signals S1 and S2 may be represented by control signals of electronic and/or optic formats.

According to one embodiment of the invention, each of the links L1₀₁, L1₁₂, L1₂₃, L1₃₄, L1₄₅ and L1₅₀ is further configured to feed electric power from the primary control unit 100 to each drive unit in the set of drive units 241, 242, 243, 244 and 245 respectively, which electric power is intended to enable the drive units to operate and thus drive the rotating platform 130. This means that the links in links L1₀₁, L1₁₂, L1₂₃, L1₃₄, L1₄₅ and L1₅₀ may be represented by power cables, and for example the first and second signals S1 and S2 as well as any error messages E1₃ and E2₄ may be transmitted on a PLC-signal format through the power cables.

FIG. 4 shows a loop configuration of galvanic connections G2₀₁, G2₁₂, G2₂₃, G2₃₄, G2₄₅ and G2₅₀ respectively that according to one embodiment of the invention interconnect the drive units 241, 242, 243, 244 and 245 in a loop configuration L2 in which a secondary control unit 110 is included, wherein the secondary control unit 110 is configured to control the operation of each of the drive units 241, 242, 243, 244 and 245. Thus, the loop configuration L2 and the secondary control unit 110 constitute an assembly being parallel to the primary control unit 100 and the ring network N1 with respect to the drive units 241, 242, 243, 244 and 245.

Each of the galvanic connections G2₀₁, G2₁₂, G2₂₃, G2₃₄, G2₄₅, and G2₅₀ is bi-directional enabling signals to pass in both directions between the secondary control unit 110 and the drive units 241, 242, 243, 244 and 245.

Specifically, third and fourth signals S3 and S4 may be passed between the secondary control unit 110 and the first drive unit 241, between the last drive unit 245 and the secondary control unit 110, as well as between each consecutive pair of the drive units between the first drive unit 241 and the last drive unit 245, i.e. between 241 and 242, between 242 and 243, between 243 and 244, and between 244 and 245.

Analogous to the above, the secondary control unit 110 is configured to identify any single faulty galvanic connection of the set of galvanic connections by:
transmitting the third signal S3 in a clockwise direction through the loop configuration L2,
transmitting a fourth signal S4 in a counter clockwise direction through the loop configuration L2, and
checking how far each of the third and fourth signals S3 and S4 respectively can be transmitted through the loop configuration L2 in the clockwise and counter clockwise direction respectively without being interrupted by the single faulty galvanic connection.

According to one embodiment of the invention the galvanic connections G2₀₁, G2₁₂, G2₂₃, G2₃₄, G2₄₅ and G2₅₀ are configured to feed electric power from the secondary control unit 110 to each drive unit in the set of drive units 241, 242, 243, 244 and 245, which electric power is intended to enable the drive units to operate and thus drive the rotating platform 130.

Consequently, the third and fourth signals S3 and S4 as well as any error messages may be transmitted on a PLC-signal format through the connections G2₀₁, G2₁₂, G2₂₃, G2₃₄, G2₄₅ and G2₅₀, for example in the form of control signals of an electronic format.

FIG. 5 shows a block diagram of a rotary milking parlor arrangement according to one embodiment of the invention in which both the primary and secondary control units 100 and 110 are included.

Here, the primary control unit 100 is configured to obtain status information Sinf via the ring network N1, which status information Sinf reflects at least one operation condition of the drive units 241, 242, 243, 244 and 245.

A central communication link CL interconnects the primary and secondary control units 100 and 110. The primary control unit 100 is further configured to repeatedly transmit the status information Sinf to the secondary control unit 110 via the central communication link CL.

According to one embodiment of the invention, the at least one operation condition reflected by the status information Sinf contains a respective indicator for each drive unit in the set of drive units 241, 242, 243, 244 and 245, which respective indicator specifies whether the drive unit operates with an acceptable level of performance.

As a result, the secondary control unit 110 will retain updated status information about the least one operation condition of the drive units 241, 242, 243, 244 and 245. Thus, the secondary control unit 110 may take over the responsibilities of the primary control unit 100 whenever necessary, for example if the primary control unit 100 malfunctions or is powered down.

In a typical implementation scenario, each of the primary and secondary control units 100 and 110 is configured to receive operating commands, and in response thereto cause the rotating platform 130 to move in the forward direction RF or the backward direction RB. The rotating platform 130 may move at a rotation speed up to a threshold speed, which is assigned based on a functioning number designating how many drive units 241, 242, 243, 244 and 245 that operate with the acceptable level of performance. The threshold speed is assigned a maximum value only if the functioning number designates that all drive units 241, 242, 243, 244 and 245 operate with the acceptable level of performance.

Namely, each of the drive units 241, 242, 243, 244 and 245 is not only engaged in accelerating and propelling the rotating platform 130, each drive unit 241, 242, 243, 244 and 245 is also equally responsible for decelerating and stopping the rotating platform 130. For safety reasons, the maximum speed can only be allowed if all drive units 241, 242, 243, 244 and 245 operate with the acceptable level of performance. Preferably, if one or more of the drive units 241, 242, 243, 244 and/or 245 operate at a reduced level of performance, the threshold speed is lowered from the maximum value in proportion to the number of drive units that operate at the reduced level of performance. Consequently, the operational safety can be held at a reasonable level even if the rotary milking parlor arrangement must be temporarily operated with one or more faulty drive units.

According to one embodiment of the invention, the arrangement includes a first user interface 501, e.g. a touchscreen, configured to convey a first set of operating commands Cmd1 to the primary control unit 100. The first set of operating commands Cmd1 is configured to control a movement of the rotating platform 130 via signalling over the ring network N1 to the set of drive units 241, 242, 243, 244 and 245. The first set of operating commands Cmd1 may include commands for initiating movement in the forward direction RF, wherein increasing the speed of movement in the forward direction RF, decreasing the speed of movement in the forward direction RF, stopping the rotating platform 130, initiating movement in the backward direction RB, increasing the speed of movement in the backward direction RB and decreasing the speed of movement in the backward direction RB may involve either automatic commands or manual operating commands.

According to this embodiment of the invention, the arrangement also includes a second user interface 502, e.g. an array of push buttons, configured to convey a second set of operating commands Cmd2 both to the primary control unit 100 and the secondary control unit 110.

Preferably, the second user interface 502 is configured to mirror at least a subset of the operating commands that are possible to generate via the first user interface 501. In any case, analogous the first set of operating commands, the second set of operating commands is configured to control the movement of the rotating platform 130.

Specifically, the second set of operating commands Cmd2 is configured to control the movement of the rotating platform 130 via signalling through the primary control unit 100 over the ring network N1 to the set of drive units 241, 242, 243, 244 and 245. Moreover, the second set of operating commands Cmd2 is configured to control the movement of the rotating platform 130 via signalling through the secondary control unit 110 over the loop configuration L2 to the set of drive units 241, 242, 243, 244 and 245. Thus, a redundant control means is accomplished through the second user interface 502 and the secondary control unit 110, which control means enhances the reliability and safety for the control of the rotating platform 130.

According to one embodiment of the invention, the secondary control unit 110 is configured to be activated exclusively if the primary control unit 100 suffers from a malfunction affecting the primary control unit's 100 capability to control the movement of the rotating platform 130. This may be advantageous, since it eliminates the risk that two users generate conflicting operating commands via the first and second user interfaces 501 and 502. Said functionality also facilitates for the user to focus his/her attention on a single user interface.

FIG. 6 illustrates the details of one of the drive units 241 according to one embodiment of the invention. Here, the drive unit 241 contains a drive motor 641 that is arranged to engage drive surfaces 661 and 662 of the rotating platform 130 via a drive wheel 650. FIG. 6 further illustrates the links L1₀₁ and L1₁₂, the galvanic connections G2₀₁ and G2₁₂, and the first, second, third and fourth signals S1, S2, S3 and S4 respectively.

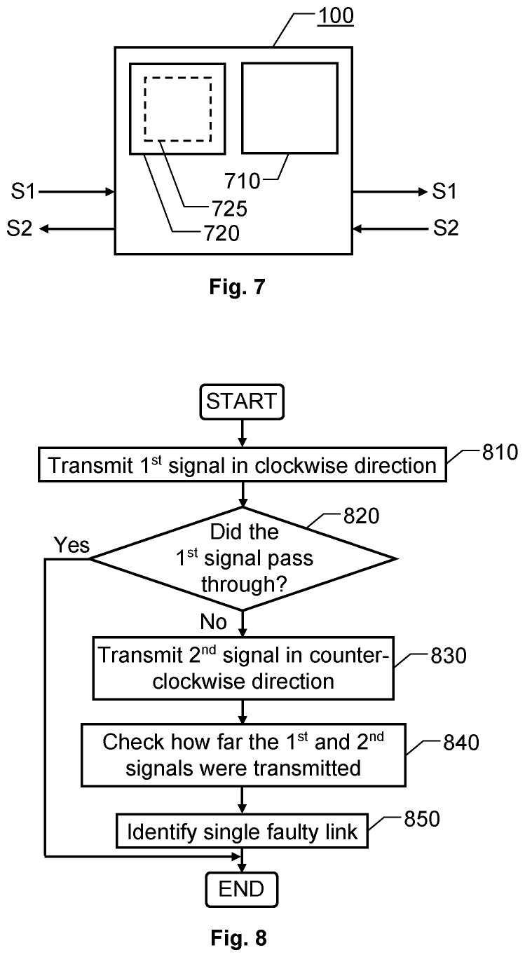

FIG. 7 shows a block diagram of the primary control unit 100 according to one embodiment of the invention. It is generally advantageous if the primary control unit 100 is configured to effect the above-described procedure in an automatic manner by executing a computer program 725. Therefore, the primary control unit 100 may include a memory unit 720, i.e. non-volatile data carrier, storing the computer program 725, which, in turn, contains software for making processing circuitry in the form of at least one processor 710 in the primary control unit 100 execute the actions mentioned in this disclosure when the computer program 725 is run on the at least one processor 710.

The secondary control unit 110 may be implemented in an analogous manner.

In order to sum up, and with reference to the flow diagram in FIG. 8, we will now describe the computer-implemented method according to the invention which is performed in a primary a control unit of a rotary milking parlor arrangement. The rotary milking parlor arrangement is presumed to include a rotating platform 130 with a plurality of stalls S each of which is configured to house a respective animal during milking. The rotary milking parlor arrangement is further presumed to include a set of at least three drive units 241, 242, 243, 244 and 245 for driving the rotating platform 130, which drive units are connected to one another as well as to the primary control unit in a ring network N1 by means of a set of bi-directional links L1₀₁, L1₁₂, L1₂₃, L1₃₄, L1₄₅ and L1₅₀.

In a first step 810, the primary control unit transmits a first signal S1 in a clockwise direction through the ring network N1.

A step 820 thereafter checks if the first signal S1 was passed through the ring network N1 back to the primary control unit; and if so, it is concluded that the links L1₁₀, L1₁₂, L1₂₃, L1₃₄, L1₄₅ and L1₅₀ function as intended and the procedure ends. If, however, it is found in step 820 that the first signal S1 did not pass through the ring network N1, a step 830 follows.

In step 830, the primary control unit transmits a second signal S2 in a counter clockwise direction through the ring network N1.

Then, in step 840, it is checked how far through the ring network N1 each of the first and second signals S1 and S2 respectively was transmitted without being interrupted by a single faulty link.

Finally, in a step 850 thereafter, the single faulty link is identified as described above with reference to FIGS. 3a to 3d.

The process steps described with reference to FIG. 8 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. Any reference signs in the claims should not be construed as limiting the scope.

It is also to be noted that features from the various embodiments described herein may freely be combined, unless it is explicitly stated that such a combination would be unsuitable. The invention is not restricted to the described embodiments in the figures, but may be varied freely within the scope of the claims.

1. A rotary milking parlor arrangement comprising:
a rotating platform (130) with a plurality of stalls (S) each of which is configured to house a respective animal during milking,
a set of drive units (241, 242, 243, 244, 245) configured to cause the rotating platform (130) to move in at least a first direction (RF, RB) of rotation around a rotation axis (P), and
a primary control unit (100) configured to control operation of each drive unit in the set of drive units (241, 242, 243, 244, 245), wherein the set of drive units (241, 242, 243, 244, 245) comprises at least three of the drive units,
a set of links (L1₀₁, L1₁₂, L1₂₃, L1₃₄, L1₄₅, L1₅₀) connecting the drive units in the set of drive units in a ring network (N1) in which the primary control unit (100) is included, wherein each said link (L1₀₁, L1₁₂, L1₂₃, L1₃₄, L1₄₅, L1₅₀) in the set of links is bi-directional enabling signals (S1, S2) to pass in both directions:
between the primary control unit (100) and a first said drive unit (241) in the set of drive units,
between a last said drive unit (245) in the set of drive units and the primary control unit (100), and
between each consecutive pair of the drive units (242, 243, 244) between the first drive unit (241) and the last drive unit (245);
the primary control unit (100) being further configured to identify any single faulty said link (L1₃₄) in the set of links by:
transmitting a first said signal (S1) in a clockwise direction through the ring network (N1),
transmitting a second said signal (S2) in a counter clockwise direction through the ring network (N1), and
checking how far each of the first and second signals (S1; S2) can be transmitted through the ring network (N1) in the clockwise and counter clockwise direction respectively without being interrupted by the single faulty link (L134).

2. The arrangement according to claim 1, wherein the links in the set of links (L1₀₁, L1₁₂, L1₂₃, L1₃₄, L1₄₅, L1₅₀) are further configured to feed electric power from the primary control unit (100) to each said drive unit in the set of drive units (241, 242, 243, 244, 245).

3. The arrangement according to claim 1, wherein the first and second signals (S1; S2) are control signals.

4. The arrangement according to claim 1, further comprising:
a secondary control unit (110) configured to control operation of each said drive unit in the set of drive units (241, 242, 243, 244, 245), and
a set of galvanic connections (G2₀₁, G2₁₂, G2₂₃, G2₃₄, G2₄₅, G2₅₀) connecting the drive units in the set of drive units in a loop configuration (L2) in which the secondary control unit (110) is included, wherein each said galvanic connection (G2₀₁, G2₁₂, G2₂₃, G2₃₄, G2₄₅, G2₅₀) in the set of galvanic connections is bi-directional enabling signals (S3, S4) to pass in both directions: between the secondary control unit (110) and the first drive unit (241) in the set of drive units, between the last drive unit (245) in the set of drive units and the secondary control unit (110), as well as between each consecutive pair of the drive units (242, 243, 244) between the first drive unit (241) and the last drive unit (245); and the secondary control unit (110) is further configured to identify any single faulty said galvanic connection of the set of galvanic connections by:
transmitting a third signal (S3) in a clockwise direction through the loop configuration (L2),
transmitting a fourth signal (S4) in a counter clockwise direction through the loop configuration (L2), and
checking how far each of the third and fourth signals (S3; S4) can be transmitted through the loop configuration (L2) in the clockwise and counter clockwise direction respectively without being interrupted by the single faulty galvanic connection.

5. The arrangement according to claim 4, wherein the galvanic connections in the set of galvanic connections (G2₀₁, G2₁₂, G2₂₃, G2₃₄, G2₄₅, G2₅₀) are further configured to feed electric power from the secondary control unit (110) to each said drive unit in the set of drive units (241, 242, 243, 244, 245).

6. The arrangement according to claim 4, wherein the third and fourth signals (S3; S4) are control signals.

7. The arrangement according to claim 4, wherein:
the primary control unit (100) is configured to obtain status information (Sinf) via the ring network (N1), which said status information (Sinf) reflects at least one operation condition of the drive units in the set of drive units (241, 242, 243, 244, 245),
the arrangement further comprises a central communication link (CL) interconnecting the primary and secondary control units (100; 110), and
the primary control unit (100) is further configured to repeatedly transmit the status information (Sinf) to the secondary control unit (110) via the central communication link (CL).

8. The arrangement according to claim 7, wherein the at least one operation condition reflected by the status information (Sinf) comprises a respective indicator for each said drive unit in the set of drive units (241, 242, 243, 244, 245) which respective indicator specifies whether a corresponding said drive unit operates with an acceptable level of performance.

9. The arrangement according to claim 8, wherein each of the primary and secondary control units (100; 110) is configured to cause the rotating platform (130) to move at a rotation speed up to a threshold speed assigned based on a functioning number designating how many of the drive units in the set of drive units (241, 242, 243, 244, 245) that operate with the acceptable level of performance, the threshold speed being assigned a maximum value only if the functioning number designates that all of the drive units in the set of drive units (241, 242, 243, 244, 245) operate with the acceptable level of performance.

10. The arrangement according to claim 4, further comprising:
a first user interface (501) configured to convey a first set of operating commands (Cmd1) to the primary control unit (100), which said first set of operating commands (Cmd1) are configured to control a movement of the rotating platform (130) via signalling over the ring network (N1) to the set of drive units (241, 242, 243, 244, 245), and
a second user interface (502) configured to convey a second set of operating commands (Cmd2) to the primary control unit (100) and the secondary control unit (110), which said second set of operating commands (Cmd2) are configured to control the movement of the rotating platform (130):
via signalling through the primary control unit (100) over the ring network (N1) to the set of drive units (241, 242, 243, 244, 245), and
via signalling through the secondary control unit (110) over the loop configuration (L2) to the set of drive units (241, 242, 243, 244, 245).

11. The arrangement according to claim 10, wherein the secondary control unit (110) is configured to be activated exclusively if the primary control unit (100) suffers from a malfunction affecting the primary control unit's (100) capability to control the movement of the rotating platform (130).

12. A computer-implemented method, which is performed in at least one processor (710) in a control unit (100; 110) of a rotary milking parlor arrangement comprising a rotating platform (130) with a plurality of stalls (S) each of which is configured to house a respective animal during milking, and a set of drive units (241, 242, 243, 244, 245), which method comprises:
controlling the set of drive units (241, 242, 243, 244, 245) to cause the rotating platform (130) to move in at least a first direction (RF, RB) of rotation around a rotation axis (P),
the set of drive units (241, 242, 243, 244, 245) comprising at least three said drive units, the arrangement further comprising a set of links (L1₀₁, L1₁₂, L1₂₃, L1₃₄, L1₄₅, L1₅₀) connecting the drive units in the set of drive units in a ring network (N1) in which a primary control unit (100) is included, wherein each said link (L1₀₁, L1₁₂, L1₂₃, L1₃₄, L1₄₅, L1₅₀) in the set of links is bi-directional enabling signals (PS1, PS2) to pass in both directions: between the primary control unit (100) and a first said drive unit (241) in the set of drive units, between a last said drive unit (245) in the set of drive units and the primary control unit (100), as well as between each consecutive pair of the drive units (242, 243, 244) between the first drive unit (241) and the last drive unit (245), and the method further comprising identifying any single faulty said link (L1₃₄) in the set of links by:
transmitting a first signal (S1) in a clockwise direction through the ring network (N1),
transmitting a second signal (S2) in a counter clockwise direction through the ring network (N1), and
checking how far each of the first and second signals (S1; S2) can be transmitted through the ring network (N1) in the clockwise and counter clockwise direction respectively without being interrupted by the single faulty link (L1₃₄).

13. The method according to claim 12, wherein the arrangement, further comprises a secondary control unit (110) configured to control operation of each said drive unit in the set of drive units (241, 242, 243, 244, 245), and a set of galvanic connections (G2₀₁, G2₁₂, G2₂₃, G2₃₄, G2₄₅, G2₅₀) connecting the drive units in the set of drive units in a loop configuration (L2) in which the secondary control unit (110) is included, wherein each said galvanic connection (G2₀₁, G2₁₂, G2₂₃, G2₃₄, G2₄₅, G2₅₀) in the set of galvanic connections is bi-directional enabling signals (S3, S4) to pass in both directions:
between the secondary control unit (110) and the first drive unit (241) in the set of drive units,
between the last drive unit (245) in the set of drive units and the secondary control unit (110), and
between each consecutive pair of the drive units (242, 243, 244) between the first drive unit (241) and the last drive unit (245); and
the method further comprises identifying any single faulty said galvanic connection of the set of galvanic connections by:
transmitting a third signal (S3) in a clockwise direction through the loop configuration (L2),
transmitting a fourth signal (S4) in a counter clockwise direction through the loop configuration (L2), and
checking how far each of the third and fourth signals (S3; S4) can be transmitted through the loop configuration (L2) in the clockwise and counter clockwise direction respectively without being interrupted by the single faulty galvanic connection.

14. The method according to claim 13, further comprising:
obtaining status information (Sinf) in the primary control unit (100) via the ring network (N1), which said status information (Sinf) reflects at least one operation condition of the drive units in the set of drive units (241, 242, 243, 244, 245), and
transmitting, repeatedly, the status information (SI) from the primary control unit (100) to the secondary control unit (110) via a central communication link (CL).

15. The method according to claim 14, wherein the at least one operation condition reflected by the status information (SI) comprises a respective indicator for each said drive unit in the set of drive units (241, 242, 243, 244, 245) which respective indicator specifies whether a corresponding said drive unit operates with an acceptable level of performance.

16. The method according to claim 15, comprising:
causing the rotating platform (130) to move at a rotation speed up to a threshold speed from either of the primary or secondary control units (100; 110), and
assigning the threshold speed assigned based on a functioning number designating how many of the drive units in the set of drive units (241, 242, 243, 244, 245) that operate with the acceptable level of performance, the threshold speed being assigned a maximum value only if the functioning number designates that all of the drive units in the set of drive units (241, 242, 243, 244, 245) operate with the acceptable level of performance.

17. The method according to claim 13, further comprising:
conveying a first set of operating commands (Cmd1) to the primary control unit (100) through a first user interface (501), and in response to the first set of operating commands (Cmd1)
controlling a movement of the rotating platform (130) via signalling over the ring network (N1) to the set of drive units (241, 242, 243, 244, 245)
conveying a second set of operating commands (Cmd2) to the primary control unit (100) and the secondary control unit (110) through a second user interface (502), and in response to the second set of operating commands (Cmd2)
controlling the movement of the rotating platform (130):
via signalling through the primary control unit (100) over the ring network (N1) to the set of drive units (241, 242, 243, 244, 245), and
via signalling through the secondary control unit (110) over the loop configuration (L2) to the set of drive units (241, 242, 243, 244, 245).

18. The method according to claim 17, comprising:
activating the secondary control unit (110) exclusively if the primary control unit (100) suffers from a malfunction affecting the primary control unit's (100) capability to control the movement of the rotating platform (130).

19. A non-volatile data carrier on which is stored a computer program (725) communicatively connected to a processing unit (710), the computer program (725) comprising software for executing the method according claim 12 when the computer program (725) is run on the processing unit (710).

20. (canceled)

21. The rotary milking parlor arrangement of claim 1, wherein each given one of the drive units is configured to:
receive said first signal by a first said link to which the given drive unit is connected;
transmit said first signal in a clockwise direction along the ring network via a second said link to which the given drive unit is connected;
determine whether the first signal transmitted via the second link has been received by a neighboring said drive unit in the ring network in the clockwise direction; and
when determining that the first signal transmitted via the second link has not been received by the neighboring drive unit in the ring network in the clockwise direction, transmit a first error message in the counterclockwise direction around the ring network to the primary control unit identifying the given drive unit and indicating that the second link is the faulty link, and
wherein each given one of the drive units is also configured to:
receive said second signal by the second link to which the given drive unit is connected;
transmit said second signal in a counterclockwise direction along the ring network via the first link to which the given drive unit is connected;
determine whether the second signal transmitted via the first link has been received by a neighboring said drive unit in the ring network in the counterclockwise direction; and
when determining that the second signal transmitted via the first link has not been received by the neighboring drive unit in the ring network in the counterclockwise direction, transmit a second error message in the clockwise direction around the ring network to the primary control unit identifying the given drive unit and indicating that the first link is the faulty link, and.
wherein each given one of the drive units is also configured to:
upon receiving the first error message, transmitting the first error message along the ring network in the counterclockwise direction, and
upon receiving the second error message, transmitting the second error message along the ring network in the clockwise direction.

22. The rotary milking parlor arrangement of claim 4, wherein each given one of the drive units is configured to:
receive said third signal by a first said galvanic connection to which the given drive unit is connected;
transmit said third signal in a clockwise direction along the loop configuration via a second said galvanic connection to which the given drive unit is connected;
determine whether the third signal transmitted via the second galvanic connection has been received by a neighboring said drive unit in the loop configuration in the clockwise direction; and
when determining that the third signal transmitted via the second galvanic connection has not been received by the neighboring drive unit in the loop configuration in the clockwise direction, transmit a first error message in the counterclockwise direction around the loop configuration to the primary control unit identifying the given drive unit and indicating that the second galvanic connection is the faulty galvanic connection, and
wherein each given one of the drive units is also configured to:
receive said fourth signal by the second galvanic connection to which the given drive unit is connected;
transmit said fourth signal in a counterclockwise direction along the loop configuration via the first galvanic connection to which the given drive unit is connected;
determine whether the fourth signal transmitted via the first galvanic connection has been received by a neighboring said drive unit in the loop configuration in the counterclockwise direction; and
when determining that the fourth signal transmitted via the first galvanic connection has not been received by the neighboring drive unit in the loop configuration in the counterclockwise direction, transmit a second error message in the clockwise direction around the loop configuration to the primary control unit identifying the given drive unit and indicating that the first galvanic connection is the faulty galvanic connection, and.
wherein each given one of the drive units is also configured to:
upon receiving the first error message, transmitting the first error message along the loop configuration in the counterclockwise direction, and
upon receiving the second error message, transmitting the second error message along the loop configuration in the clockwise direction.

23. The rotary milking parlor arrangement of claim 12, wherein each given one of the drive units is configured to:
receive said first signal by a first said link to which the given drive unit is connected;
transmit said first signal in a clockwise direction along the ring network via a second said link to which the given drive unit is connected;
determine whether the first signal transmitted via the second link has been received by a neighboring said drive unit in the ring network in the clockwise direction; and
when determining that the first signal transmitted via the second link has not been received by the neighboring drive unit in the ring network in the clockwise direction, transmit a first error message in the counterclockwise direction around the ring network to the primary control unit identifying the given drive unit and indicating that the second link is the faulty link, and
wherein each given one of the drive units is also configured to:
receive said second signal by the second link to which the given drive unit is connected;
transmit said second signal in a counterclockwise direction along the ring network via the first link to which the given drive unit is connected;
determine whether the second signal transmitted via the first link has been received by a neighboring said drive unit in the ring network in the counterclockwise direction; and
when determining that the second signal transmitted via the first link has not been received by the neighboring drive unit in the ring network in the counterclockwise direction, transmit a second error message in the clockwise direction around the ring network to the primary control unit identifying the given drive unit and indicating that the first link is the faulty link, and.
wherein each given one of the drive units is also configured to:
upon receiving the first error message, transmitting the first error message along the ring network in the counterclockwise direction, and
upon receiving the second error message, transmitting the second error message along the ring network in the clockwise direction.

24. The rotary milking parlor arrangement of claim 13, wherein each given one of the drive units is configured to:
receive said third signal by a first said galvanic connection to which the given drive unit is connected;
transmit said third signal in a clockwise direction along the loop configuration via a second said galvanic connection to which the given drive unit is connected;
determine whether the third signal transmitted via the second galvanic connection has been received by a neighboring said drive unit in the loop configuration in the clockwise direction; and
when determining that the third signal transmitted via the second galvanic connection has not been received by the neighboring drive unit in the loop configuration in the clockwise direction, transmit a first error message in the counterclockwise direction around the loop configuration to the primary control unit identifying the given drive unit and indicating that the second galvanic connection is the faulty galvanic connection, and
wherein each given one of the drive units is also configured to:
receive said fourth signal by the second galvanic connection to which the given drive unit is connected;
transmit said fourth signal in a counterclockwise direction along the loop configuration via the first galvanic connection to which the given drive unit is connected;
determine whether the fourth signal transmitted via the first galvanic connection has been received by a neighboring said drive unit in the loop configuration in the counterclockwise direction; and
when determining that the fourth signal transmitted via the first galvanic connection has not been received by the neighboring drive unit in the loop configuration in the counterclockwise direction, transmit a second error message in the clockwise direction around the loop configuration to the primary control unit identifying the given drive unit and indicating that the first galvanic connection is the faulty galvanic connection, and.
wherein each given one of the drive units is also configured to:
upon receiving the first error message, transmitting the first error message along the loop configuration in the counterclockwise direction, and
upon receiving the second error message, transmitting the second error message along the loop configuration in the clockwise direction.
